(19) United States
(12) Patent Application Publication
(10) Pub. No.: US 2020/0250751 A1
(43) Pub. Date: Aug. 6, 2020

(54) METHOD, SYSTEM, AND COMPUTER TRADING PLATFORM FOR VALUING AND EXCHANGING FLATTED SHARES OF A PRIVATE COMPANY

(71) Applicant: CAPBRIDGE CORNERSTONE PTE. LTD., Singapore (SG)

(72) Inventor: Wai LAM, Singapore (SG)

(21) Appl. No.: 16/753,803

(22) PCT Filed: Oct. 9, 2018
(86) PCT No.: PCT/SG2018/050510

§ 371 Date: Apr. 6, 2020

(30) Foreign Application Priority Data
Oct. 9, 2017 (SG) 10201708322R

(51) Int. Cl. G06Q 40/04; G06Q 30/08; G06Q 10/10; G06N 20/00

(52) U.S. Cl. CPC G06Q 40/04; G06N 20/00; G06Q 10/105; G06Q 30/08

(57) ABSTRACT

A method for valuing and exchanging flatted shares of a private company using a computerized trading platform includes receiving company ownership data including a number of securities in one or more investment classes held by a plurality of shareholders in the private company. A transaction price is computed for buying flatted shares in a special purpose vehicle (SPV) using an auction algorithm based on the bidding price for each of the buy orders from a plurality of investors in the SPV for identifying a set of investors from the plurality of investors whose buy orders include bidding prices larger than or equal to the computed transaction price. Upon assessing that a criterion for SPV formation is met, a buy-back of a portion of a number of securities held by at least one selling shareholder is performed and the flatted SPV shares are issued to the set of investors.

### FIELD OF THE INVENTION

The present invention relates to a trading platform for exchanging shares of a company, and more specifically to a method, system, and computer trading platform for valuing and exchanging flatted shares of a private company.

### BACKGROUND OF THE INVENTION

Shares in a private company are typically arranged in different classes. Each class, or share class, has numerous voting and economic rights, which are binding on the shareholders holding securities in a particular share class. These rights may limit or even prevent the shareholder from selling all or a portion of his shares, if the shareholder decides to reduce his ownership in the private company, even when there is a willing buyer. In many instances, the shareholder must wait until the company goes public where his shareholdings may be sold to the public.

Furthermore, the voting and economic rights attached to each of the different share classes may further limit potential investors from investing in the private company. Even when there are willing buyers and sellers for shares in the private company, it may difficult to facilitate a trade. Private exchanges have traditionally failed as securities in the different share classes were not tradable due to the innate differences of these rights in the share classes, the difficulty to value and agree on a transaction price for these rights.

Thus, it may be desirable to have a method and system to facilitate trading shares of a private company between existing shareholders willing to sell all or part of their existing shareholdings in the private company with potential investors.

### SUMMARY OF THE INVENTION

There is provided, in accordance with some embodiments of the present invention, a method for valuing and exchanging flatted shares of a private company using a computerized trading platform may include receiving, in a processor, company ownership data in a private company including a number of securities in one or more investment classes held by a plurality of shareholders in the private company. Company valuation data of the private company including a price per security for each of the one or more investment classes is received. A reserve price per security in the one or more investment classes based on the price per security in the one or more investment classes in the valuation data is determined. The reserve price per security for each of the one or more investment classes is sent to the plurality of shareholders in the private company. Sell orders to sell a portion of the number of securities in the one or more investment classes is received from at least one selling shareholder from the plurality of shareholders in the private company, where the sell orders are based on the reserve price per company share in the one or more investment classes. The reserve price per security for each of the one or more investment classes and the sell orders to sell the portion is sent to potential investors in a special purpose vehicle (SPV) to be formed based on the private company. Buy orders are received from a plurality of investors to buy flatted SPV shares in the SPV to be formed, where each buy order from the plurality of investors includes a bidding price and a number of flatted SPV shares to be purchased. A transaction price is computed for buying the flatted SPV shares using an auction algorithm based on the bidding price for each of the buy orders from the plurality of investors in the SPV so as to identify a set of investors from the plurality of investors whose buy orders include bidding prices larger than or equal to the computed transaction price. A final buy-back price per security in the one or more investment classes for the at least one selling shareholder is computed from a swap-ratio applied to a total investor equity value of all the buy orders from the identified set of investors. Upon assessing that a criterion for SPV formation is met, a buy back of the portion of the number of securities held by the at least one selling shareholder is performed with the final buy-back price per security in the one or more investment classes and the flatted SPV shares are issued to the identified set of investors.

Furthermore, in accordance with some embodiments of the present invention, assessing that the criterion for SPV formation is met may include assessing that an equity value of flatted SPV shares to be bought by the identified set of investors based on the transaction price is larger than an equity value of the portion of the number of securities to be sold by the at least one selling shareholder from the plurality of shareholders.

Furthermore, in accordance with some embodiments of the present invention, assessing that the criterion for SPV formation is met may include validating that funds to purchase flatted SPV shares by the identified set of investors is held in escrow.

Furthermore, in accordance with some embodiments of the present invention, the method may include, upon SPV formation, updating the company ownership data and listing the SPV on the computer trading platform.

Furthermore, in accordance with some embodiments of the present invention, determining the reserve price may include using a reserve ratio fixed by the private company to compute the reserve price.

Furthermore, in accordance with some embodiments of the present invention, determining the reserve price may include using a reserve ratio derived from a machine learning algorithm to compute the reserve price.

Furthermore, in accordance with some embodiments of the present invention, the securities in the one or more investment classes are selected from the group consisting of ordinary shares, common shares, ordinary equivalent shares, series preference shares, convertible bonds, treasury shares, convertible loans, employee stock options (ESOP), warrants, and options.

Furthermore, in accordance with some embodiments of the present invention, the auction algorithm is selected from the group consisting of a Dutch auction algorithm, and a first-come, first served auction algorithm.

There is further provided, in accordance with some embodiments of the present invention, a computerized trading platform for valuing and exchanging flatted shares of a private company may include a memory and a processor. The processor may be configured to receive company ownership data in a private company including a number of securities in one or more investment classes held by a plurality of shareholders in the private company, to receive company valuation data of the private company including a price per security for each of the one or more investment classes, to determine a reserve price per security in the one or more investment classes based on the price per security in the one or more investment classes in the valuation data, to send the reserve price per security for each of the one or more investment classes to the plurality of shareholders in the private company, to receive sell orders to sell a portion of the number of securities in the one or more investment classes from at least one selling shareholder from the plurality of shareholders in the private company, wherein the sell orders are based on the reserve price per company share in the one or more investment classes, to send the reserve price per security for each of the one or more investment classes and the sell orders to sell the portion to potential investors in a special purpose vehicle (SPV) to be formed based on the private company, to receive buy orders from a plurality of investors to buy flatted SPV shares in the SPV to be formed, wherein each buy order from the plurality of investors comprises a bidding price and a number of flatted SPV shares to be purchased, to compute a transaction price for buying the flatted SPV shares using an auction algorithm based on the bidding price for each of the buy orders from the plurality of investors in the SPV so as to identify a set of investors from the plurality of investors whose buy orders include bidding prices larger than or equal to the computed transaction price, to compute a final buy-back price per security in the one or more investment classes for the at least one selling shareholder from a swap-ratio applied to a total investor equity value of all the buy orders from the identified set of investors, and upon assessing that a criterion for SPV formation is met, to perform a buy back of the portion of the number of securities held by the at least one selling shareholder with the final buy-back price per security in the one or more investment classes and issue the flatted SPV shares to the identified set of investors.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a system for valuing and exchanging flatted shares of a private company using a computer trading platform, in accordance with some embodiments of the present invention;

FIG. 2 shows a graph of the total number of bids versus the bidding price per share used for determining a transaction price using a Dutch auction, in accordance with some embodiments of the present invention;

FIG. 3 is a table listing an equity value and a price per security of shareholders in a private company, in accordance with some embodiments of the present invention;

FIG. 4 is a table listing a reserve price and an equity value of securities to be sold by selling shareholders, in accordance with some embodiments of the present invention;

FIG. 5 are two tables illustrating an investor equity value and a transaction price for buying flatted special purpose vehicle (SPV) shares by investors, in accordance with some embodiments of the present invention;

FIG. 6 is a table listing swap ratios and a final price per security to be received by selling shareholders, in accordance with some embodiments of the present invention;

FIG. 7 is a flowchart depicting a method for valuing and exchanging flatted shares of private company using trading platform, in accordance with some embodiments of the present invention; and

FIG. 8 schematically illustrates a blockchain system for valuing and exchanging flatted shares of a private company using a plurality of computers, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Embodiments of the present invention herein describe a method, system, and computer trading platform to facilitate trading securities issued by a private company and held by existing shareholders willing to sell all or part of their existing shareholdings in the private company to potential investors. Shareholders in the private company may hold securities in different investment classes, or share classes, each share class with different rights binding on the shareholder. These rights associated with securities of the different share classes may prevent the shareholder from being able selling all or part of shares held in the different share class since this may, for example, result in a loss of rights for other shareholders holding securities in the same share class.

In the context of this present application, the terms “share class” and “investment class” may be used interchangeably herein. Investment classes may include, for example, ordinary shares, series A, B, C, D, . . . shares issued in different investment rounds, employee stock options issued in different investment rounds, warrants issued in different investment rounds, and convertible bonds issued in different investment rounds.

In some embodiments of the present invention, a hybrid trading solution may be implemented on a trading platform operated by a service provider, where securities held by shareholders in one or more different investment classes in the private company may be sold via the trading platform. In parallel, the private company may then advertise to potential inventors via the trading platform the intent to issue flatted shares in a special purpose vehicle (SPV) float along with the equity value of the securities that the selling shareholders wish to sell. The potential investors who may wish to purchase the flatted shares in the SPV, may place orders to buy the flatted shares, each order with a bidding price and the number of flatted SPV shares to purchase via the trading platform.

On the seller side, the trading platform may calculate and/or the private company may fix a reserve price and a relative swap-ratio for each of the one or more investment classes of securities using a mathematical model implemented in the trading platform software based on the valuation of the company prior to the SPV formation. After reviewing the reserve prices advertised on the trading platforms applied to the sale prices of the securities to be sold by the selling shareholder, the selling shareholders may place orders via the trading platform to sell all or part of their security holdings in the one or more investment classes. At SPV formation, the selling shareholders are paid by the private company based on the calculated swap-ratio using money held in escrow from funds paid by the buyers for the purchase of the SPV flatted shares. Administration fees paid to the service provider of the trading platform may be included.

On the buyer side, once the trading platform receives all of the buy orders from potential investors, each order with the bidding price and the number of flatted SPV shares to purchase, the trading platform may execute an auction algorithm implemented in the trading platform software to determine the transaction price of the SPV flatted shares issued to the buyers. Administration fees for the service provider may also be included in the final transaction price.

The SPV formation campaign succeeds if the demand for purchasing SPV flatted shares as determined by the number of buy orders with bidding prices above the reserve price is more than the supply of SPV shares to be issued (e.g., the transaction price from the auction algorithm is greater than the reserve price). Otherwise the SPV formation campaign may not succeed unless the reserve prices decrease, or the existing shareholders purchase flatted SPV shares. When the conditions for SPV formation are met, the private company issues flatted SPV shares in a single flatted share class at the transaction price, while buying back the securities from the selling shareholders using the fluids from the buyers held in escrow.

In this manner, shareholders have a mechanism using this hybrid trading solution to sell all or a portion of their security holding, while still preserving existing shareholder rights for those shareholders who still wish to retain their security holdings in the private company. This hybrid trading solution allows shareholders to gain liquidity. Conversely, new potential investors may invest in the private company via the purchase of the flatted SPV shares. The SPV flatted shares, also known herein as vanilla shares, once issued may then be traded on a private exchange. Furthermore, by the trading platform advertising the online valuation data, such as the capitalization table, for example, and executing the auction algorithm to determine the transaction price, company shareholders are at no risk of default, since the transaction (e.g., the formation of the SPV) is only completed when all the conditions of SPV formation are met (e.g., secondary financing campaigns are met). In this manner, the private company and shareholders are at no time at risk.

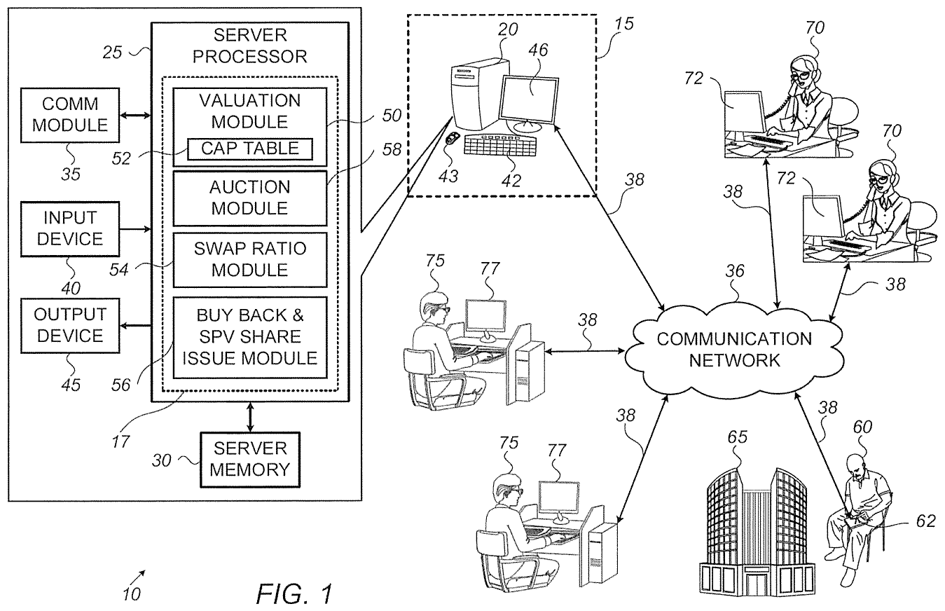

FIG. 1 schematically illustrates a system 10 for valuing and exchanging flatted shares of a private company 65 using a computer trading platform 15, in accordance with some embodiments of the present invention. Computer trading platform 15 may include a server 20. Server 20 may include a server processor 25, a server memory 30, a communication module 35, an input device 40, and an output device 45. Server 20 may also be referred to herein as a cloud server where data may be stored in the cloud, for example, in server memory 30.

A trading platform software 17 may be stored in server memory 30 and may be executed by server processor 25. In some embodiments, trading platform software 17 may be configured to receive information from external databases as inputs to the software. For example, an external server may already have acquired company ownership data, company valuation data, and any other relevant metrics of private company 65, such as the cap tables, the valuation prices, or reserve ratio which can be input into trading platform software 17. These different parameters will be further discussed below.

In some embodiments of the present invention, a shareholder 70 may observe information about private company 65 sent from trading platform 15 displayed on a terminal 72. Similarly, shareholder 70 may input information and may enter trading orders in terminal 72 which are sent to trading platform 15 operating on server 20. The information relayed between terminal 72 and server 20 may be communicated 38 via a communication network 36, such as the internet, a cellular data network, a satellite network, for example. A customized application or a web browser operating on terminal 72 may be used to display information from trading platform 15 and to receive information from shareholder 70 which may be inputted into terminal 72 and relayed 38 to server 20 via communication network 36.

In some embodiments of the present invention, an investor 75 may observe information sent from trading platform 15 displayed on a terminal 77. Similarly, investor 75 may input information and may enter trading orders in terminal 77 which are sent to trading platform 15 operating on server 20. The information relayed between terminal 77 and server 20 may be communicated 38 via communication network 36. A customized application or a web browser, for example, operating on terminal 77 may be used to display information from trading platform 15 and to receive information from investor 75 which may be input into terminal 77 and relayed 38 to server 20 via communication network 36. Users of trading platform 15 may include but are not limited to investors 75 and shareholders 70. Users may be any persons given access to trading platform 15.

Communication module 35 in server 20 may include, for example, cellular, Wireless Fidelity (Wi-Fi), satellite communication, and/or Bluetooth circuitry interfaced to an antenna (not shown), for example. Communication module may include circuitry for wired connections, such as ethernet, for example, for communicating 38 with shareholders 70 and investors 75 via terminals 72 and 77, respectively.

Server processor 25 may include one or more processing units, e.g. of one or more computers. Server processor 25 may be configured to operate in accordance with programmed instructions stored in server memory 30. Computer trading platform 15 may be implemented in software, stored in server memory 30, and executed by server processor 25.

Server processor 25 may communicate with output device 45. For example, output device 45 may include a computer display 46 or screen. Server processor 25 may communicate with a screen of output device 45 to display output information from computer trading platform 15. In another example, output device 45 may include a printer, display panel, speaker, or another device capable of producing visible, audible, or tactile output.

Server processor 25 may communicate with input device 40. For example, input device 40 may include one or more of a keyboard 42, keypad, or pointing device 43 (e.g., a mouse) for enabling a user to inputting data or instructions for operation of server processor 25.

Server processor 25 may communicate with server memory 30. Server memory 30 may include one or more volatile or nonvolatile memory devices. Server memory 30 may be utilized to store, for example, programmed instructions for operation of server processor 25, data or parameters for use by server processor 25 during operation, or results of operation of server processor 25.

In operation, server processor 25 may execute a method for valuing and exchanging flatted SPV shares of private company 65 using computer trading platform 15.

In some embodiments of the present invention, trading platform software 17 may include software modules such as a valuation module 50 with a capitalization table (cap table) 52 of private company 65, an auction module 58 for executing the auction algorithms, a swap-ratio module 54, and a buy back & SPV share issue module 56.

In some embodiments of the present invention, a valuation agent 60 may provide a valuation of private company 65. The company valuation data, such as cap table 52 of private company 65, may be entered, for example, on a computing device such as a desktop, laptop, or mobile device 62 and relayed 38 to valuation module 50 operating on server 20 via communication network 36. In other embodiments, valuation module 50 may use valuation algorithms to formulate the valuation data of private company 65.

Table I is a list of variable names and variable definitions used in the following equations herein, as well as the meaning of the superscripts and the subscripts attached to the variable names.

The following is a description of the steps in the valuation of private company 65, advertising of a campaign to buy back shares from existing shareholders in exchange for issuing flatted shares in an SPV related to the private company, and finally leading to the formation of the SPV, in accordance with some embodiments of the present invention.

In some embodiments of the present invention, a meeting of shareholders in private company 65 may review the outstanding security holding by shareholders. The securities held by a plurality of shareholders may be allocated in different investment or share classes such as, for example, ordinary shares, ordinary share equivalents, series A, B, C, D shares, employee stock options, convertible bonds, and warrants as shown in Table I.

TABLE I
List of definitions of variable names, subscripts,
and superscripts used herein
Variable Name and Definition

| | |
|---|---|
| NS | No. of Security |
| PPS | Price per Security |
| EV | Equity Value of Security |
| RR | Reserve Ratio |
| CR | Conversion Ratio |
| AF | Admin Fee |

Meaning of Superscripts attached to the Variable Name

| | |
|---|---|
| OS | Ordinary Shares (e.g., equivalent to common shares) |
| OSE | Ordinary Share Equivalent (on fully diluted basis |
| | calculations) taking into account conversion for all |
| | convertibles, warrants, options, etc . . . |
| A, B, C, D | Series shares A, B, C, D and so on investment round. |
| | Representing typical naming convention for |
| | subsequent rounds of fundraising beyond ordinary |
| | shares where the specific series of shares are issued. |
| ESOP1, ESOP 2, | Employee Stock Options round 1, 2, 3, etc . . . with |
| | each number representing a subsequent investment and |
| | funding round. |
| CB1, CB2, CB3 | Convertible Bonds round 1, 2, 3, etc . . . with each |
| | number representing a subsequent investment and |
| | funding round. |
| W1,W2, W3 | Warrants round 1, 2, 3, etc . . . with each number |
| | representing a subsequent investment and funding |
| | round. |

Meaning of Subscripts attached to the Variable Name

| | |
|---|---|
| 1 | EV and PPS of All Existing Shares |
| 2 | EV and PPS of Only Selling Shareholders |
| 3 | EV and PPS of Investor Bids for OSE |
| 4 | EV and PPS of Final Transaction |

In some embodiments of the present invention, the shareholders and/or the management of private company 65 may provide company ownership data including the creation of capitalization table 52, also known herein as cap table 52. Cap table 52 may include all of securities issued in the one or more investment classes and share equivalents (e.g., convertible bonds, for example) and held by all of the plurality of shareholders. The company ownership data may also include the material shareholder rights associated with each of the one or more investment classes. The company ownership data may be uploaded to server 20 and stored in memory 30.

Cap Table 52 may be represented by a spreadsheet, or by a digital representation (“Online Cap Table”) hosted on the cloud (e.g., uploaded to server 20 and stored in memory 30). The company ownership data may be accessible by users via an internet browser running, for example, on terminals 72 and 77. The online cap table may include relevant investment agreements and shareholder agreements, uploaded by private company 65 to memory 30 in server 20. In some embodiments, material share terms can be converted into structured data in the online cap table, and may be verified by the lawyers of a 3rd party professional. For example, the type of liquidation preference and ratio can be converted from legal documentation into structured fields of the online cap table.

In some embodiments of the present invention, shareholders 70 may verify their identify by logging into trading platform 15 via an internet browser operating on terminal 72 to claim their shareholdings and share tiers. In some embodiments, ordinary shares, common shares, preference shares, convertible bonds, treasury shares, convertible loans, employee stock options (ESOP), warrants, and options, as well as any other instrument, which when exercised or converted, shall entitle the holder to receive equity in the company, may also be “claimed”. In that shareholders own part of private company 65 by holding securities held in the one or more investment classes, each security may have an ordinary share equivalent (OSE) for each security type to account for the different values of each security unit. As a result, each security type in the one or more investment classes may be placed on an equivalent equity value scale when advertising the campaign to form the SPV. For example, a shareholder of 1 convertible bond that converts to 2 ordinary shares (e.g., a Conversion Ratio=2), then the number of OSE held by that holder is 2 as given by:

NS₁^{CB1(OSE)}=NS₁^{CB1}×CR^{(CB1 to OSE)} (1)

The total number of shares on a fully diluted basis is given by the sum of all total OSE from the one or more investment classes, e.g., all share class and convertibles, is given by:

NS₁^{Total(OSE)}=NS₁^{CB1(OSE)}+NS₁^{OS}+NS₁^{A(OSE)}+NS₁^{B(OSE)}+NS₁^{ESOP(OSE)}+ . . . (2)

In some embodiments of the present invention, once the shareholder and share terms of private company 65 are verified, the price per security (PPS) for each security in the one or more investment classes (e.g., share class and share convertible) may be determined based on a valuation of private company 65 as follows.

The valuation data of private company 65, such as the equity value for the total ordinary share equivalent for selling shareholders (e.g. EV₂^{Total(OSE)}) and the PPS of each the one or more investment classes, may be determined by a third party professional valuation agent (e.g., valuation agent 60). Valuation agent 60 may use a combination of valuation methods such as Option Pricing Model (OPM), Discounted Cash Flow Analysis (DCF), and market comparables for formulating the valuation data. In some embodiments, based on inputs from valuation agent 60 and/or other external company data, valuation module 50 may use valuations algorithms to formulate the valuation data (e.g., automated valuation) as will be described herein below.

In some embodiments, the valuation data may include a price per security PPS for each of the one or more investment classes (e.g., share class or share convertible). For example, when a price per security of a Series A share is USD 2 as valued by the valuation methods described above (e.g., PPS₁^{A}=USD 2), the total equity value (EV) of all existing Series A shares given 1,000 outstanding Series A Shares in total is given by:

EV₁^{A}=PPS₁^{A}×NS₁^{A}=2*1000=USD 2000 (3)

In some embodiments of the present invention, the management or shareholders of private company 15, and/or automated algorithms executed in trading platform 15, may then fix a reserve price for each security in the one or more investment classes (e.g., share class and share convertible). The reserve price indicates the PPS for each security in the one or more investments classes that private company 65 may use to buy-back the securities held by the plurality of shareholders in the one or more investment classes during the SPV float.

In some embodiments of the present invention, the reserve price may be set using a standard reserve ratio (RR) which may be applied to the PPS of all share classes. In some embodiments, RR may be used to determine a relationship between the valuation and the reserve price, since the valuation model may already incorporate a liquidity discount into the valuation method. For example, if a RR of 0.7 is applied where PPS₁^{A}=USD 2, for example, then the price per security of series A shares offered to shareholders willing to sell their series A shares in the SPV float is given by:

PPS₂^{A}=PPS₁^{A}×RR=USD 2*0.7=USD 1.40 (4)

In some embodiments of the present invention, the reserve ratio may be determined by reference data based on the reserve ratios used by similar companies at similar investment stages from a structured database accessed over communication network 36 or stored on a database on server memory 30. Over time, trading platform 15 may be configured to use machine learning algorithms to automatically determine the reserve ratio for private company 65 based on the reference data in the structured database.

In some embodiments of the present invention, trading platform 15 (e.g., server processor 25) may then send to shareholders 70, via communication network 36, the price per security (e.g., PPS₂) for each security in the one or more investment classes (e.g., share class and share convertible) for display on terminal 72 that the company will use to buy back the securities held by the plurality of shareholders who are willing to sell all or a part of their security holdings. In response, shareholders 70 may place orders via the web browser on terminal 72 to sell all or a part of their securities held in the one or more investment classes and to participate in the buy-back during the SPV float for the fixed reserve ratio.

For example, out of a total 1000 Series A Shares held by the plurality of shareholders, at least one shareholder from the plurality of shareholders 70 may indicate their willingness to accept a PPS₂^{A} of 1.40 to sell 500 series A shares from the outstanding 1000 shares. Thus, the total equity value of the 500 series A shares that the at least one shareholder from the plurality of shareholders is willing to sell is given by:

EV₂^{A}=PPS₂^{A}×NS₂^{A}=USD 1.40×500 shares=USD 700 (5)

The total equity value of the portion of outstanding number of securities for sale held by at least one shareholder from the plurality of shareholders is given by:

EV₂^{Total}=+EV₂^{OS}+EV₂^{A}+EV₂^{CB}+ . . . (6)

Similarly, the portion, or the total number of ordinary equivalent shares (OSE) in the one or more investment classes indicated for sale by the at least one shareholder from the plurality of shareholders is given by:

NS₂^{Total(OSE)}=NS₂^{OS}+NS₂^{A(OSE)}+NS₂^{CB(OSE)}+ . . . (7)

The number of securities of ordinary share equivalents (OSE) of selling shareholders may then be calculated based on the conversion ratio for securities in each of the one or more investment classes (e.g., each share class or share convertibles) converting to ordinary share equivalents (OSE).

The total price per security for OSE may be given by:

PPS₂^{Total(OSE)}=EV₂^{Total}÷NS₂^{Total(OSE)} (8)

In some embodiments of the present invention, trading platform 15 (e.g., server processor 25) may then send to investors 75, via communication network 36, the price per security (e.g., PPS₂) for each security in the one or more investment classes (e.g., share class and share convertible) for display on terminal 77 that the company will use to buy back the securities held by the plurality of shareholders, who are willing to sell all or a part of their security holdings, and the portion of the outstanding securities that the plurality of shareholders are willing to sell. In advertising this information to potential investors, investors 75 may conduct their due diligence on the buy-back data in the SPV formation campaign provided by trading platform 15.

In response, investors 75, via a web browser operating on terminal 77, may place buy orders on trading platform 15 for flatted SPV shares based on the private company to buy SPV shares based on knowledge of the advertised PPS₂^{Total(OSE)} and NS₂^{Total(OSE)}, where each buy order from the plurality of potential investors in the SPY includes a bidding price per share (e.g., PPS₃^{OSE}) and the number of flatted SPV shares to be purchased based on the bidding price.

In some embodiments of the present invention, when all of the bid orders, sent from terminal 77 from investors 75 to trading platform 15 via communication network 36, are placed, server processor 25 may then compute the total number of bids for ordinary (flatted) shares in the SPV to be formed (e.g., NS₃^{Total}) that are successful such that PPS₃^{OSE}>PPS₂^{TOTAL(OSE)}.

In some embodiments of the present invention, trading platform 15 may then compute the transaction price for investors 75, having placed online bids, to purchase flatted SPV shares using auction algorithms in auction module 58. Auction module 58 may use various auction matching mechanisms such as first-come, first-serve auction mechanism, and a Dutch type auction mechanism, for example. Server processor 25 may assess if the SPV formation campaign is successful upon verifying that the total number of bids for flatted SPV shares is greater than the portion, or the total number of ordinary equivalent shares (OSE) in the one or more investment classes indicated for sale by the at least one shareholder from the plurality of shareholders, e.g., NS₃^{Total}>NS₂^{Total}.

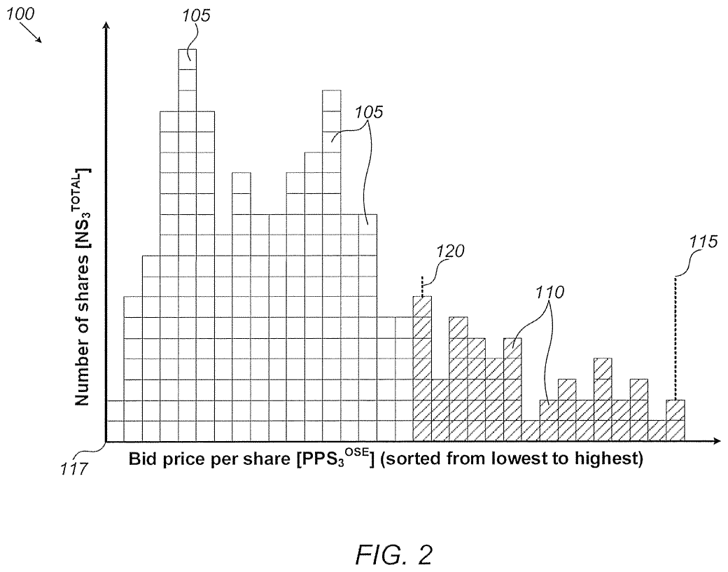

FIG. 2 shows a graph 100 of the total number of bids versus the bidding price per share used for determining a transaction price 120 using a Dutch auction, in accordance with some embodiments of the present invention. A Dutch type auction mechanism may be used to find the highest price in which the flatted SPV shares may be sold. Server processor 25 may sort bids 105 from a highest bidding price 115 to a lowest bidding price 117. A final price 120 that fills the quota of shares to sell becomes transaction price 120 (e.g., PPS₃^{OSE}). Successful bids 110 are between highest bidding price 115 to final price 120.

In some embodiments, the total equity value EV₄^{Total(OSE)} of the transaction for issuing the SPV flatted shares less an administration fee (AF), a fee paid to private company 65 and the service provider is given by:

EV₄^{Total(OSE)}=(PPS₄^{OSE}×NS₃^{Total})−AF (9)

In this manner, the fees paid to private company 65 is a method of providing an incentive to the company for performing the SPV float campaign and remunerating the company for its efforts should the SPV formation campaign be successful. The collection of the administration fees in the manner set forth in Equation (9) is shown by way of example, and not a limitation of the embodiments of the present invention. Administration fees may be collected in any suitable manner.

In some embodiments of the present invention, the equity value of the portion of the number of securities held by the at least one selling shareholder in the buy-back of the portion may be distributed to the selling shareholders on a relative equity value basis. For example,

if EV₂^{Total}=EV₂^{OS}+EV₂^{A}+EV₂^{CB}, (10)

then EV₄^{CB}=EV₂^{CB}÷EV₂^{Total}*EV₄^{Total(OSE)} (11)

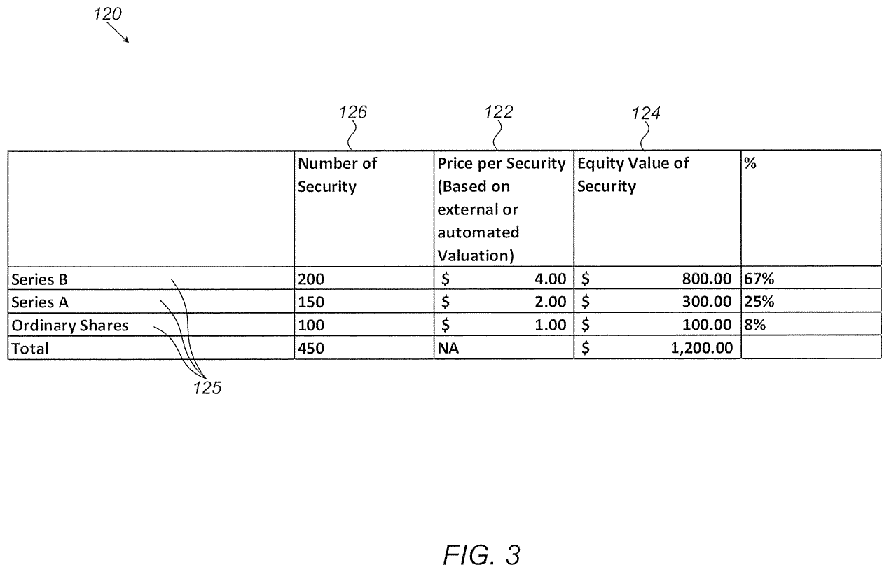

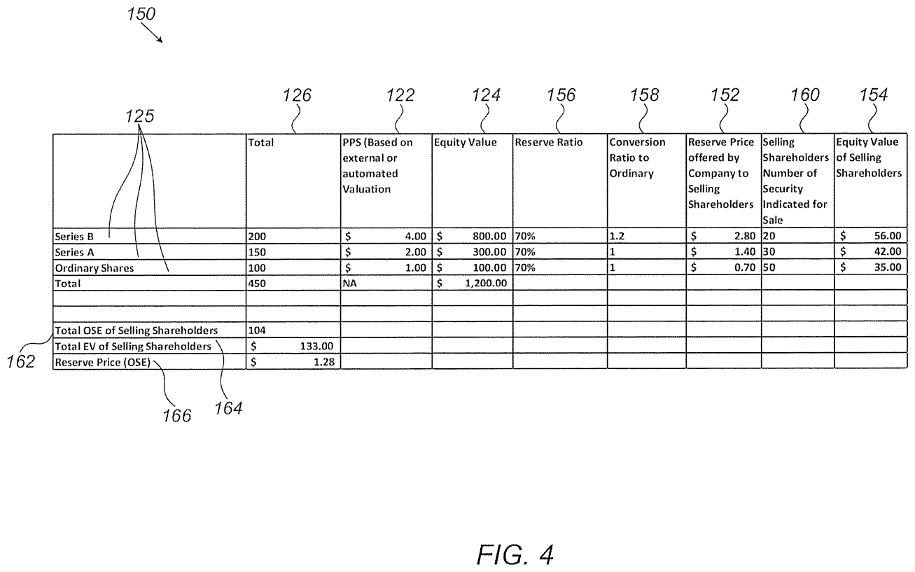

FIGS. 3-6 illustrate a series of exemplary computations used for valuing and exchanging flatted shares of private company 65 using trading platform 15, in accordance with some embodiments of the present invention. The example computations shown in FIGS. 3-6 are merely for conceptual clarity and not by way of limitation of the embodiments of the present invention.

FIG. 3 is a table 120 listing an equity value 124 and price per security 122 of shareholders in private company 65, in accordance with some embodiments of the present invention. Valuation agent 60 may assess and/or valuation module 50 (e.g., automated valuation) may compute the price per security 122 for each of investment classes 125. Equity value 124 for each of investment classes 125 may be computed from a number of securities 126 held by the plurality of shareholders 70.

FIG. 4 is a table 150 listing a reserve price 152 and an equity value 154 of securities to be sold by selling shareholders, in accordance with some embodiments of the present invention. The management and/or shareholders of private company 65 may set a reserve ratio 156 and a conversion ratio to ordinary shares 152 for each of investment classes 125. Reserve price 152 may be computed as the product of PPS 152 and reserve ratio 156 for each of investment classes 125.

Each shareholder 70 on terminal 72 may then enter a sale order to sell all or a part their shareholdings. Trading platform 15 may then count a number of securities 160 indicated for sale by the selling shareholders (e.g., at least one selling shareholder). The total number of ordinary share equivalents (OSE) for each of investment classes 125 may be scaled by multiplying number of securities 160 indicated for sale by conversion ratio to ordinary shares 152 for each of investment classes 125. Thus, a total number of OSE of selling shareholders 162 for the example shown in FIG. 4 is 104. Total equity of selling shareholders 164 is $133. Thus, the reserve price per OSE 166 is $1.28.

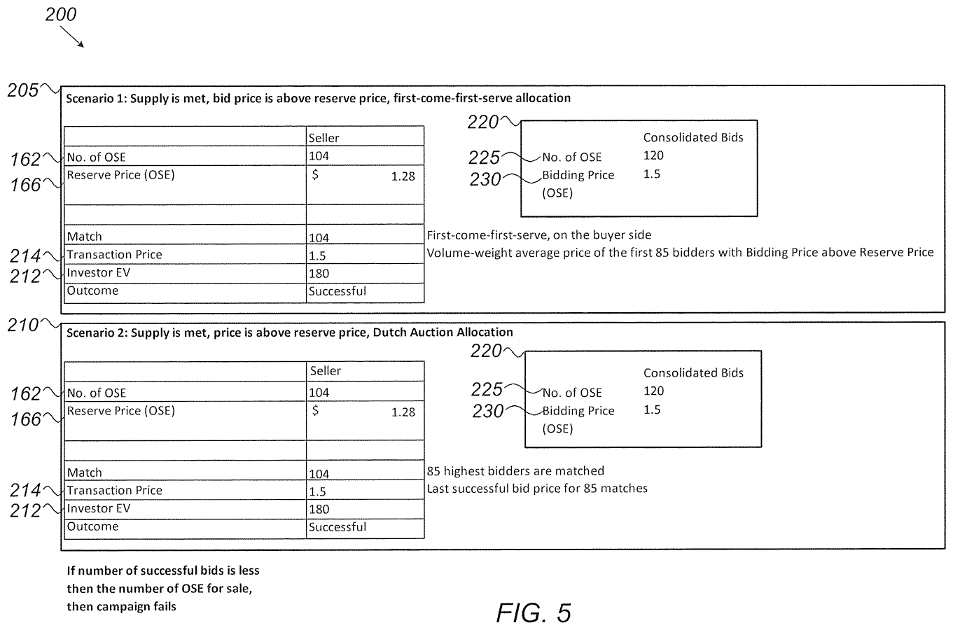

FIG. 5 are two tables 200 illustrating an investor equity value 212 and transaction price 214 for buying flatted special purpose vehicle (SPV) shares by investors 75, in accordance with some embodiments of the present invention. In a first scenario 205, auction module 58 uses a first come, first serve auction algorithm to compute a transaction price 214 for investors 75 to purchase the flatted SPV shares. After investors 75 enter buy orders for the flatted SPV shares on terminal 77, server processor 25 consolidates all of the buy orders into consolidated bids 220 where the total number of OSE 225 in consolidated bids 220 is 120. The bidding price (OSE) 230 is $1.5 in this example shown in FIG. 5. Applying the first come, first serve auction algorithm, the equity value of the investor bids 212 that are successful is $180 (e.g., $1.5×120).

In a second scenario 210, auction module 58 uses a Dutch auction algorithm as in FIG. 2 to compute a transaction price 214 for investors 75 to purchase the flatted SPV shares. After investors 75 enter buy orders for the flatted SPV shares on terminal 77, server processor 25 consolidates all of the buy orders into consolidated bids 220 where the total number of OSE 225 in consolidated bids 220 is 120. The bidding price (OSE) 230 is $1.5 in this example shown in FIG. 5. Applying the Dutch auction algorithm, the equity value of the investor bids 212 that are successful is $180 (e.g., $1.5×120).

In each of the scenarios 205 and 210, if the number of OSE 225 from consolidated bids is less than the number of OSE for sale 162, then the campaign for SPV formation for private company 65 fails. In this case, reserve price 166 needs to be reduced and/or more shareholders need to buy flatted SPV shares to increase the chances that the campaign will be successful.

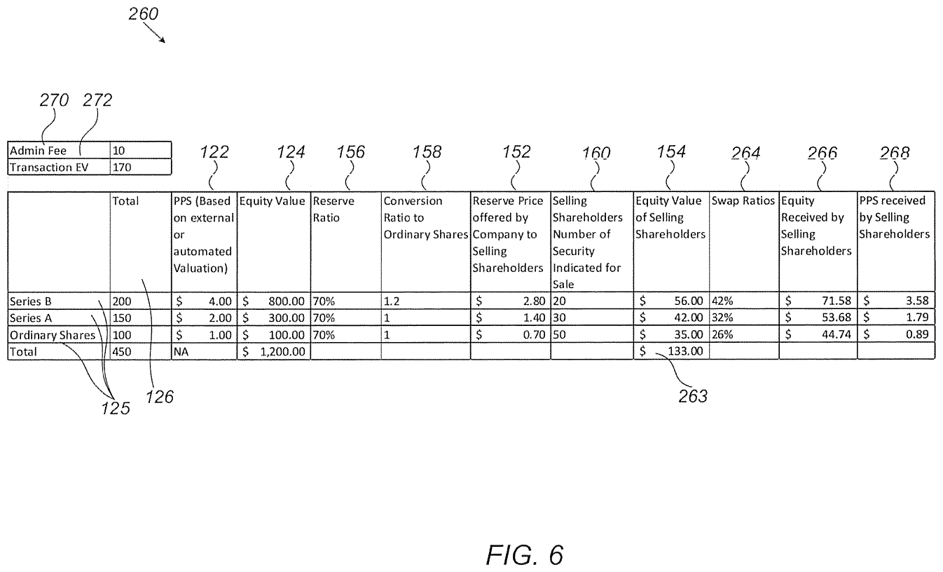

FIG. 6 is a table 260 listing swap ratios 264 and a final price per security 268 to be received by selling shareholders, in accordance with some embodiments of the present invention. Table 260 illustrates how the selling shareholders are reimbursed for their securities sold when the SPV is established and the flatted SPV shares issued to the buying investors. A transaction equity value (EV) 272 of the campaign may be computed by Investor EV 212 from FIG. 5 less the administration fees 270.

In some embodiments of the present invention, swap ratio module 54 computes a swap ratio 264 for each of investment classes 125 by taking equity value 154 of the selling shareholder for each of investment classes 125 divided by the total equity value 263 of all of the securities to be sold in each of investment classes 125.

Buy back & SPV share issue module 56 computes an equity received by selling shareholders 266 at SPV formation in each of investment classes 125 by multiplying swap ratio 264 by transaction EV 272 for each of investment classes 125. Buy back & SPV share issue module 56 computes a final PPS 268 (e.g., a final buy-back price) for securities in each of investment classes 125 to be received in a buy-back by selling shareholders by dividing equity received by selling shareholders 266 by number of securities for sale 160 in each of investment classes 125.

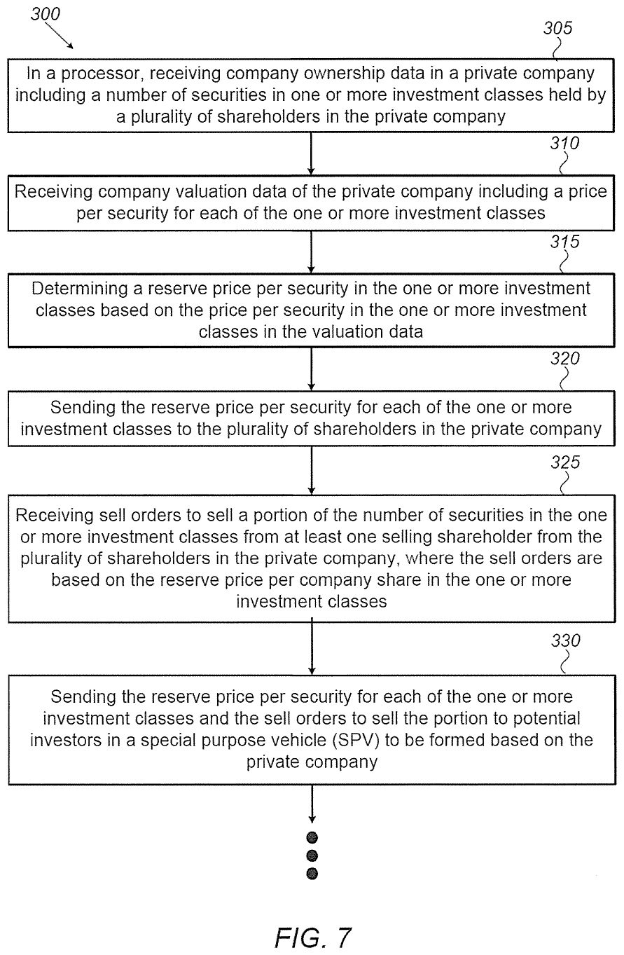

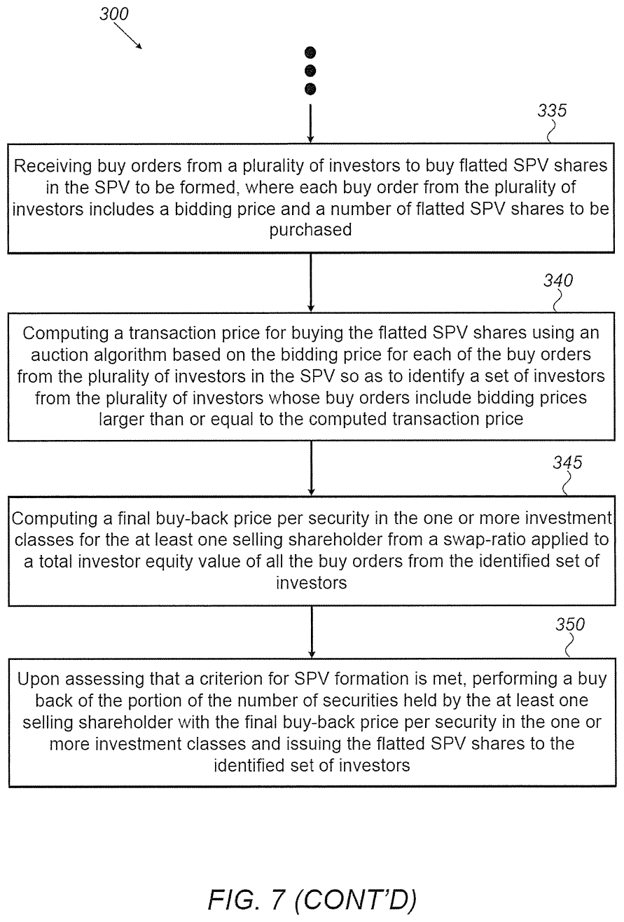

FIG. 7 is a flowchart depicting a method 300 for valuing and exchanging flatted shares of private company 65 using trading platform 15, in accordance with some embodiments of the present invention. In the example of FIG. 7, method 300 may be executed by server processor 25 of system 10.

Method 300 may include receiving 305 company ownership data in a private company including a number of securities in one or more investment classes held by a plurality of shareholders in the private company.

Method 300 may include receiving 310 company valuation data of the private company including a price per security for each of the one or more investment classes.

Method 300 may include determining 315 a reserve price per security in the one or more investment classes based on the price per security in the one or more investment classes in the valuation data.

Method 300 may include sending 320 the reserve price per security for each of the one or more investment classes to the plurality of shareholders in the private company.

Method 300 may include receiving 325 sell orders to sell a portion of the number of securities held in the one or more investment classes from at least one selling shareholder from the plurality of shareholders in the private company, where the sell orders are based on the reserve price per company share in the one or more investment classes.

Method 300 may include sending 330 the reserve price per security for each of the one or more investment classes and the sell orders to sell the portion to potential investors in a special purpose vehicle (SPV) to be formed based on the private company.

Method 300 may include receiving 335 buy orders from a plurality of investors to buy flatted SPV shares in the SPV to be formed, where each buy order from the plurality of investors includes a bidding price and a number of flatted SPV shares to be purchased.

Method 300 may include computing 340 a transaction price for buying the flatted SPV shares using an auction algorithm based on the bidding price for each of the buy orders from the plurality of investors in the SPV so as to identify a set of investors from the plurality of investors whose buy orders include bidding prices larger than or equal to the computed transaction price.

Method 300 may include computing 345 a final buy-back price per security in the one or more investment classes for the at least one selling shareholder from a swap-ratio applied to a total investor equity value of all the buy orders from the identified set of investors.

Method 300 may include, upon assessing that a criterion for SPV formation is met, performing 350 a buy-back of the portion of the number of securities held by the at least one selling shareholder with the final buy-back price per security in the one or more investment classes and issuing the flatted SPV shares to the identified set of investors.

In some embodiments of the present invention, method 300 may include upon assessing that a criterion for SPV formation is met, trading platform 15 may list the portion of the number of securities held by the at least one selling shareholder to be bought back by the private company and the flatted SPV shares to be issued the identified set of investors. In other embodiments, method 300 may include upon assessing that a criterion for SPV formation is met, trading platform 15 may perform a buy back of the portion of the number of securities held by the at least one selling shareholder and issue the flatted SPV shares to the identified set of investors.

In some embodiments of the present invention, the criterion for SPV formation may include assessing that an equity value of the flatted SPV shares to be bought by the identified set of investors based on the transaction price is larger than an equity value of the portion of the number of securities to be sold by the at least one selling shareholder from the plurality of shareholders. In other embodiments, the criterion for SPV formation may include validating that funds to purchase the flatted SPV shares by the identified set of investors is held in escrow.

In some embodiments of the present invention, method 300 may include upon SPV formation, updating the company ownership data and listing the SPV on the trading platform 15.

In some embodiments of the present invention, valuation data may be obtained using automated valuation. Private company 65 referred to hereinbelow as the target company may be compared to the valuation data of a basket of similar “comparable” companies. This information may be parsed from an external database and uploaded to trading platform 15. A “Comps Table” as shown herein below in Table II for the target company may be formulated. The Comps Table may be generated using keywords, descriptions, characteristics, size, funding history of comparable companies (e.g., comparables). A “similarity” coefficient may be generated by using clustering algorithms and/or neural networks. The similarity coefficients may then be used to compare the target company with the actual comparables, or even the comparables of a competitor company of the target company may also be used in the analyses.

Information about each comparable with respect to the following metrics may be accounted for. These metrics may include, for example, ordinary share prices, other share prices and terms, relative share price between the ordinary shares and the other shares, and relative share terms between ordinary shares and other shares. A regression algorithm or similar algorithms may be used to determine the correlation between the relative share price and share terms. The regression algorithm may be used to predict the share price of the target company given the similarity between the share terms and the actual share price, as well as share terms from the comparables of the target company. These regression algorithms may be used in conjunction with the OPM and DCF algorithms (e g, methods) as previously described. Stated differently, the final algorithm may use a weighted average of different algorithms.

In some embodiments of the present invention, automated valuation may be performed in three steps. In a first step, server processor 25 may parse data of different companies from a database stored in server memory 30, or stored on an external database accessible via communication network 36. Server processor 25 may determine comparable companies (e.g., comparables) as shown in Table II. In a second step, server processor 25 may determine the equity value of the target company, as well as a valuation effect of objective share terms of various share classes. Finally, in a third step, server processor 25 may determine a valuation effect of non-objective share terms of various share classes and adjust the valuation accordingly. as shown in Table III herein below.

With regard to the first step and Table II, each company may be categorized by description tags. Description tags may be organised into clusters to determine the relative relationships or “closeness” with one another. Example clusters may include “Healthcare and biotech” which is “closer” (e.g., closely related similarity areas) than “healthcare and financial services”. Organizing clusters and assigning relationship measures (e.g., closeness) may be performed using machine learning algorithms and natural language processing, for example. Description tags may also be dynamically created by server processor 25 using machine learning, and separately verified. Server processor 25 may be used to generate a “similarity” coefficient as shown in Table II. Other factors such as funding raised, revenue, and the number of employees may be taken into account in generating the similarity coefficient.

TABLE II
Determination of Comparable Companies
and Similarity Coefficient

| | Target | Compar- | Compar- | Compar- |
|---|---|---|---|---|
| | Company | able 1 | able 2 | able 3 |
| Description | Biotech, | Healthcare, | Biotech, | Biotech, |
| Tags | cancer, | | Pharmaceu- | healthcare, |
| | healthcare, | | ticals, | diagnostics, |
| | medicine, | | COPD, | |
| | diagnostics | | | |
| Funding | USD 40 | USD 500 | USD 100 | USD 200 |
| Raised (MM) | | | | |
| Revenue (MM) | USD 10 | USD 0 | USD 20 | USD 10 |
| No. of | 50 | 30 | 60 | 50 |
| Employees | | | | |
| “Similarity” | N.A | 0.5 | 0.7 | 0.8 |
| Coefficient | | | | |

TABLE III
Determination Valuation Effects of Non-objective Share
Terms of various share classes and Adjust Valuation

| | Target | | | |
|---|---|---|---|---|
| | Company | Comparable 1 | Comparable 2 | Comparable 3 |
| “Similarity” | N.A | 0.5 | 0.7 | 0.8 |
| Coefficient | | | | |
| Total Equity | Standard | USD 100 | USD 150 | USD |
| value | Valuation | MM | MM | 300 |
| | Methods | | | |
| Ordinary | TBD (See | USD 30 MM | USD 50 MM | USD 150 |
| Shares | below) | | | |
| Series A | TBD (See | USD 70 MM | USD 100 MM | USD 150 |
| | below) | | | |
| Ordinary Share | | USD 1 | USD 1 | USD 1 |
| PPS | | | | |
| Series A Shares | | USD 1.5 | USD 1.7 | USD 2 |
| PPS | | | | |
| Relative PPS of | | 1.5 x | 1.7 x | 2 x |
| Series A to | | | | |
| Ordinary Share | | | | |

Series A Share Terms

| | | | | |
|---|---|---|---|---|
| Share Terms A | Type 1 | Type 1 | Type 3 | Type 2 |
| Effect | +5 to 15% | +5 to 15% | −5 to 15% | +10% to 20% |
| Share Terms B | Type 2 | Type 2 | Type 2 | Type 3 |
| | +10 to 20% | +10 to 20% | +10 to 20% | +50% to 300% |
| Final Result | 1.6x | | | |

With regard to the second step with the similarity coefficient previously established, the equity value of each comparable is known as well as the equity value, number of shares and Price per share of each share class. Separately, share terms of each share class of each comparable are known. Server processor 25 may calculate the total equity value of the target company using standard DCF, Comparables, Probability-Weighted Expected Return Method (PWERM), for example.

Each share class of the target company may also include drag along rights, tag along rights, liquidation preference types, liquidity reference ratios, redemption rights, registration lights, voting rights, reserved rights, cumulative and noncumulative dividends, anti-dilution, protective provisions, conversion rights, for example. The share terms may be classified into objective share terms, in which they can be quantified using standard valuation methods, or non-objective share terms which may not be quantified using standard valuation methods. For objective share terms, such as liquidation preferences, for example, server processor 25 may use a hybrid method using the algorithm as described herein. Standard algorithms and methods such as OPM may also be used.

With regard to the third step, Table III illustrates a method for determining valuation effects of non-objective share terms of various share classes and adjusting the valuation from “similarity coefficients” of previously established comparable companies, in accordance with some embodiments of the present invention. Non-objective share terms may be categorized into broad types (e.g., Type 1, Type 2, Type 3), which may have different positive and negative effects on the relative share price. These effects may be retrospectively calculated by server processor 25 using machine learning algorithms, such as regression. Server processor 25 may calculate the final relative PPS of Series A to ordinary shares of the target company using from the sum of all the effects of the share terms, weighted accordingly with the similarity coefficient. Server processor 25 may calculate the final PPS of the share class of the target company.

In some embodiments of the present invention, the same “similarity” coefficient as discussed in Tables II and III may be used, for example, to glean the reserve ratio from the reserve ratios of prior-transacted, comparable companies. This information may be integrated with existing data sets on different databases. Note that the exemplary embodiments and calculations shown in Tables II and III are merely for conceptual clarity and not by way of limitation of the embodiments of the present invention.

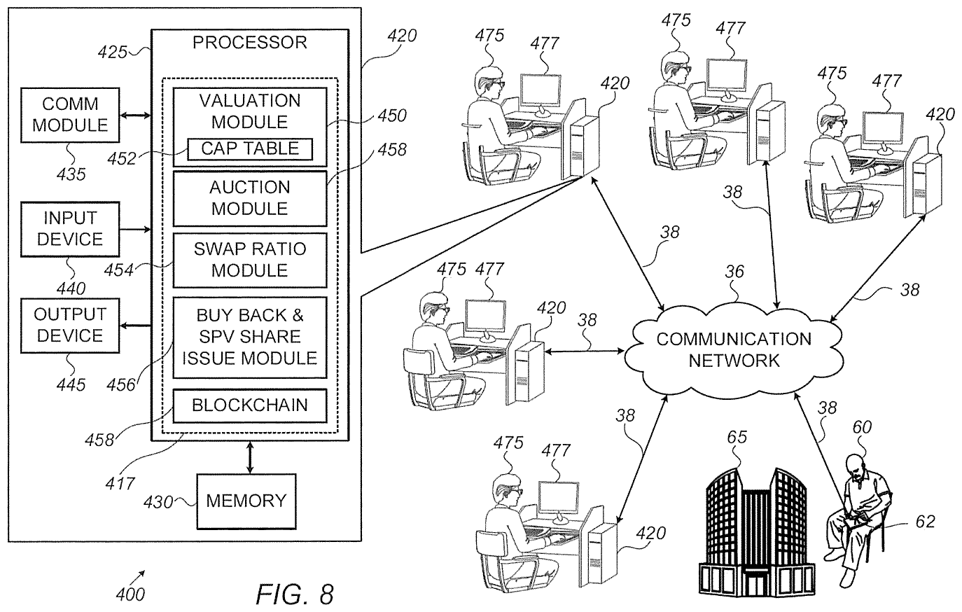

FIG. 8 schematically illustrates a blockchain system 400 for valuing and exchanging flatted shares of private company 65 using a plurality of computers 420, in accordance with some embodiments of the present invention. Each computer 420 may operate similarly to server 20 in FIG. 1. Each computer 420 may include a processor 425, a memory 430, a communication module 435, an input device 440, and an output device 445.

A trading platform software 417 may be stored in memory 430 and may be executed by processor 425. In some embodiments, a trading platform software 417 may be configured to receive information from external databases as inputs to the software. For example, an external server may already have acquired company ownership data, company valuation data, and any other relevant metrics of private company 65, such as the cap tables, the valuation prices, or reserve ratio which can be input into trading platform software 417.

In the embodiments shown in blockchain system 400, data is shared with all participants (e.g., users 475), and their capability to read, or write data unto the blockchain is determined by “smart contracts”, which are mini-programs that are relayed from computer to computer in the plurality of computers 420 via communication network 36 in blockchain system 400.

In some embodiments of the present invention, users 475, such as shareholders and/or investors, may observe information about private company 65 displayed on output device 445 such as display 477. Similarly, users 475 may input information on input device 440 and may enter trading orders on computer 420 via smart contracts which may be relayed between users 475 via communication network 36.

In some embodiments of the present invention, trading platform software 417 on each of the plurality of computers 420 may include software modules such as a valuation module 450 with a capitalization table (cap table) 452 of private company 65, an auction module 458 for executing the auction algorithms, a swap-ratio module 454, a buy back & SPV share issue module 456, and a blockchain module 458 for managing the smart contracts relayed between the plurality of computers 420 in blockchain system 400.

Communication module 435 in each computer 420 may include, for example, cellular, Wireless Fidelity (Wi-Fi), satellite communication, and/or Bluetooth circuitry interfaced to an antenna (not shown), for example. Communication module may include circuitry for wired connections, such as ethernet, for example, for communicating 38 with users 475 via computers 420, respectively.

Processor 425 in each terminal 477 may include one or more processing units, e.g. of one or more computers. Processor 425 may be configured to operate in accordance with programmed instructions stored in memory 430.

Processor 425 in each computer 420 may communicate with output device 445. For example, output device 445 may include a computer display or screen. Processor 425 may communicate with a screen 477 of output device 445 to display output information on screen 477. In another example, output device 445 may include a printer, display panel, speaker, or another device capable of producing visible, audible, or tactile output.

Processor 425 may communicate with input device 440. For example, input device 440 may include one or more of a keyboard, keypad, or pointing device (e.g., a mouse) for enabling a user to inputting data or instructions for operation of processor 425.

Processor 425 may communicate with memory 430. Memory 430 may include one or more volatile or nonvolatile memory devices. Memory 430 may be utilized to store, for example, programmed instructions for operation of processor 425, data or parameters for use by processor 425 during operation, or results of operation of processor 425.

In operation, processor 425 may execute a method for valuing and exchanging flatted SPV shares of private company 65 using blockchain technology.

In some embodiments of the present invention, valuation agent 60 may provide a valuation of private company 65. The company valuation data, such as a cap table 452 of private company 65, may be entered, for example, on a computing device such as a desktop, laptop, or mobile device 62 and relayed 38 to valuation module 450 operating on each computer 420 via communication network 36. In other embodiments, valuation module 450 may use valuation algorithms as previously described to formulate the valuation data of private company 65.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for valuing and exchanging flatted shares of a private company using a computerized trading platform, the method comprising:
in a processor, receiving data about a plurality of securities, each security is associated with one or more investment classes, the securities are held by a plurality of shareholders in a private company;
determining a reserve price per security in the one or more investment classes based on a price per security in the one or more investment classes;
sending the reserve price per security for each of the one or more investment classes to the plurality of shareholders in the private company;
receiving sell orders to sell a portion of the number of securities in the one or more investment classes from at least one selling shareholder from the plurality of shareholders in the private company, wherein the sell orders are based on the reserve price per company share in the one or more investment classes;
sending the reserve price per security for each of the one or more investment classes and the sell orders to sell the portion to potential investors in a special purpose vehicle (SPV) to be formed based on the private company;
receiving buy orders from a plurality of investors to buy flatted SPV shares in the SPV to be formed, wherein each buy order from the plurality of investors comprises a bidding price and a number of flatted SPV shares to be purchased;
computing a transaction price for buying the flatted SPV shares based on the bidding price for each of the buy orders from the plurality of investors in the SPV so as to identify a set of investors from the plurality of investors whose buy orders include bidding prices larger than or equal to the computed transaction price;
computing a final buy-back price per security in the one or more investment classes for the at least one selling shareholder from a swap-ratio applied to a total investor equity value of all the buy orders from the identified set of investors; and
upon assessing that a criterion for SPV formation is met, performing a buy back of the portion of the number of securities held by the at least one selling shareholder with the final buy-back price per security in the one or more investment classes and issuing the flatted SPV shares to the identified set of investors.

2. The method of claim 1, further comprising receiving company ownership data of the private company, the company ownership data is associated with the one or more securities associated with the one or more investment classes.

3. The method of claim 2, further comprising receiving company valuation data of the private company including a price per security for each of the one or more investment classes.

4. The method of claim 1 wherein the reserve price for any security is set by the owner of said security.

5. The method of claim 1, wherein the computing a transaction price for buying the flatted SPV shares is performed by using an auction algorithm.

6. The method according to claim 1, wherein assessing that the criterion for SPV formation is met comprises assessing that an equity value of flatted SPV shares to be bought by the identified set of investors based on the transaction price is larger than an equity value of the portion of the number of securities to be sold by the at least one selling shareholder from the plurality of shareholders.

7. The method according to claim 1, wherein assessing that the criterion for SPV formation is met comprises validating that funds to purchase flatted SPV shares by the identified set of investors is held in escrow.

8. The method according to claim 2, further comprising upon SPV formation, updating the company ownership data and listing the SPV on the computer trading platform.

9. The method according to claim 1, wherein determining the reserve price comprises using a reserve ratio fixed by the private company to compute the reserve price.

10. The method according to claim 1, wherein determining the reserve price comprises using a reserve ratio derived from a machine learning algorithm to compute the reserve price.

11. The method according to claim 1, wherein the securities in the one or more investment classes are selected from the group consisting of ordinary shares, common shares, ordinary equivalent shares, series preference shares, convertible bonds, treasury shares, convertible loans, employee stock options (ESOP), warrants, and options.

12. The method according to claim 5, wherein the auction algorithm is selected from the group consisting of a Dutch auction algorithm, and a first-come, first served auction algorithm.

13. A computerized trading platform for valuing and exchanging flatted shares of a private company, the computerized trading platform comprising:
a memory; and
a processor configured to receive data about a plurality of securities, each security is associated with one or more investment classes, the securities are held by a plurality of shareholders in a private company; to determine a reserve price per security in the one or more investment classes based on a price per security in the one or more investment classes; to send the reserve price per security for each of the one or more investment classes to the plurality of shareholders in the private company; to receive sell orders to sell a portion of the number of securities in the one or more investment classes from at least one selling shareholder from the plurality of shareholders in the private company, wherein the sell orders are based on the reserve price per company share in the one or more investment classes; to send the reserve price per security for each of the one or more investment classes and the sell orders to sell the portion to potential investors in a special purpose vehicle (SPV) to be formed based on the private company; to receive buy orders from a plurality of investors to buy flatted SPV shares in the SPV to be formed, wherein each buy order from the plurality of investors comprises a bidding price and a number of flatted SPV shares to be purchased; to compute a transaction price for buying the flatted SPV shares based on the bidding price for each of the buy orders from the plurality of investors in the SPV so as to identify a set of investors from the plurality of investors whose buy orders include bidding prices larger than or equal to the computed transaction price; to compute a final buy-back price per security in the one or more investment classes for the at least one selling shareholder from a swap-ratio applied to a total investor equity value of all the buy orders from the identified set of investors; and upon assessing that a criterion for SPV formation is met, to perform a buy back of the portion of the number of securities held by the at least one selling shareholder with the final buy-back price per security in the one or more investment classes and issuing the flatted SPV shares to the identified set of investors.

14. The computerized trading platform according to claim 13, wherein the processor is configured to receive company ownership data of the private company, the company ownership data is associated with the one or more securities associated with the one or more investment classes.

15. The computerized trading platform according to claim 13, wherein the processor is configured to receive company valuation data of the private company including a price per security for each of the one or more investment classes.

16. The computerized trading platform according to claim 13, wherein the reserve price for any security is set by the owner of said security.

17. The computerized trading platform according to claim 13 wherein the processor is configured to use an auction algorithm to determine the transaction price for buying the flatted SPV shares.

18. The computerized trading platform according to claim 13, wherein the processor is configured to assess that the criterion for SPV formation is met by assessing that an equity value of flatted SPV shares to be bought by the set of investors based on the transaction price is larger than an equity value of the portion of the number of securities to be sold by the at least one selling shareholder from the plurality of shareholders.

19. The computerized trading platform according to claim 13, wherein the processor is configured to assess that the criterion for SPV formation is met by validating that funds to purchase flatted SPV shares by the identified set of investors is held in escrow.

20. The computerized trading platform according to claim 14, wherein, upon SPV formation, the processor is configured to update the company ownership data and list the SPV on the computer trading platform.

21. The computerized trading platform according to claim 13, wherein the processor is configured to determine the reserve price by using a reserve ratio fixed by the private company to compute the reserve price.

22. The computerized trading platform according to claim 13, wherein the processor is configured to determine the reserve price by using a reserve ratio derived from a machine learning algorithm to compute the reserve price.

23. The computerized trading platform according to claim 13, wherein the securities in the one or more investment classes are selected from the group consisting of ordinary shares, common shares, ordinary equivalent shares, series preference shares, convertible bonds, treasury shares, convertible loans, employee stock options (ESOP), warrants, and options.

24. The computerized trading platform according to claim 17, wherein the auction algorithm is selected from the group consisting of a Dutch auction algorithm, and a first-come, first served auction algorithm.
